(19) United States
(12) Patent Application Publication
(10) Pub. No.: US 2004/0251253 A1
(43) Pub. Date: Dec. 16, 2004

(54) Device for solvent extraction in a microwave field

(76) Inventors: Rainer Zenter, Graz (AT); Johannes Zach, Graz (AT); Markus Lafer, Markt Hartmannsdorf (AT); Peter Kettlsch, Graz (AT)

Correspondence Address: BACON & THOMAS, PLLC, 625 SLATERS LANE, FOURTH FLOOR, ALEXANDRIA, VA, 22314

(21) Appl. No.: 10/805,529

(22) Filed: Mar. 22, 2004

(30) Foreign Application Priority Data
Mar. 21, 2003 (DE) 103 13 873.0

(51) Int. Cl. H05B 6/64

(52) U.S. Cl. 219/757; 219/702

(57) ABSTRACT

The invention relates to apparatus for extracting solvents in a microwave field, having a microwave oven (11) which comprises at least one microwave generator (12), a control unit (13) and at least one microwaving chamber (14), said chamber being fitted with venting apertures (23) and at least one suction exhaust aperture (24) which is connected by an exhaust air line (25) to a source of partial vacuum (26), further comprising a rotor (16) rotatably mounted in said chamber and fitted with several specimen receptacles (18) that may be loaded with solvent. The apparatus is characterized in that a flow detector (28) is mounted downstream of the suction exhaust aperture (24), said detector reducing or preferably shutting off the power output of the microwave generator (12) when detecting a flow of air which is less than a predetermined limit value, said airflow limit value being selected in a manner precluding forming an explosive mixture of solvent and air in said chamber. Preferably the specimen receptacles (18) are designed as pressure-resistant receptacles advantageously fitted with throttled overpressure valves (35).

The present invention relates to apparatus extracting solvents in a microwave field using a microwave oven comprising at least one microwave generator, a control unit and at least one microwaving chamber, said chamber being fitted with venting apertures and at least one suction exhaust connected by an exhaust conduit to a source of partial vacuum, further comprising a rotor which is rotatably mounted in said chamber and which comprises several specimen receptacles that may be filled with solvent.

Such solvent extracting devices are known. Illustrative the European patent application EP 0 628 332 A describes an explosion-safe, microwave heated extraction device. A sufficiently polar solvent to absorb microwave radiation and convert it into heat is used for solvent extraction in a microwave field. Alternatively mixtures of polar and non-polar solvents may be used, the polar solvent portion assuring microwave absorption and mixture heating. Typically organic solvents such as acetone, cyclohexane, ethanol, methanol etc. are used for extraction Many of these organic solvents will form explosive mixtures with air in certain ranges of concentrations, and said mixtures may be ignited by the irradiated microwave field. Conventionally solvent extraction is carried out in closed specimen containers. If there are defective seals or also a sudden, uncontrolled rise of pressure within the specimen container, then solvent vapors may escape from it into the microwaving chamber and constitute an explosive mixture therein. Said EP 0 628 332 A document proposes continuously venting the microwaving chamber and to mount a solvent sensor in an exhaust conduit, said sensor upon detecting solvents then shutting off the entire electrical system of the extraction device.

While this known device reliably detects leaks in the specimen containers, the manufacturing costs of this device are significantly higher because of the need for sensitive and sufficiently specific solvent sensors. Moreover the rotor as a rule is fitted with 5 to 20 specimen containers, each one of said containers allowing separate extraction procedures. If there should be only one malfunction in one of the specimen containers, said solvent detector shall shut down the entire device, as a result of which the extractions in the remaining specimen containers also are precluded from being carried out in the right manner.

Accordingly it is the objective of the present invention to propose apparatus extracting solvents in a microwave field, where said apparatus offers reliable protection against explosion in simple and economical manner.

This industrial problem is solved by the solvent extracting apparatus defined in the appended claim 1.

Therefore the object of the present invention is apparatus extracting solvent in a microwave field, comprising a microwave oven including a microwave generator, a control unit and at least one microwaving chamber, said chamber being fitted with venting apertures and with at least one exhaust aperture connected through an exhaust conduit to a source of partial vacuum, further comprising a rotor which is mounted in rotatable manner in said chamber and which is fitted with several specimen receptacles that may be filled with solvent. The apparatus of the present invention is characterized in that a flow detector is mounted downstream of the suction exhaust aperture and lowers the power output of the microwave generator when detecting an air flow that is less than a predetermined limit value, said airflow limit value being selected in a manner to preclude formation of an explosive solvent/air mixture in the said chamber. In this manner the present invention assures that enough air shall constantly be moved through the microwaving chamber during solvent extraction that, in the event of solvent vapors issuing by leaks or excessive pressure rises within the said receptacle from one or more of the specimen receptacles, the solvent concentration in the ensuing solvent/air mixture always shall remain below the lower explosion limit of the particular solvent. In one embodiment mode of the present invention, the user may enter through the control unit the particular solvent data into the apparatus and the required minimum flow of air shall then be determined individually. In another embodiment mode of the present invention, the number of specimen receptacles also may be entered. Illustratively the user may take into account that as regards solvents such as cyclohexane, n-hexane or methanol, the lower explosion limit already is reached at a concentration of about 40 g/m³, whereas the lower explosion limit of such solvents as dichloromethane is about 450 g/m³. In still another embodiment mode of the apparatus of the present invention, the limit value for the minimum required air flow also may be selected to be so high that explosion-safe operation of the said apparatus shall be assured for practically all solvents used in solvent extraction procedures.

The apparatus of the present invention is designed in a manner that in the event of leaks or of excessive pressure in one or more specimen receptacles, continuation of extraction nevertheless shall be feasible and reliable. If the detected flow of air were to drop below the predetermined limit value, explosive mixtures might form within the microwaving chamber. In a first embodiment mode of the invention, the microwave generator power output may be reduced to begin with, and optionally countermeasures such as raising the volumetric rate of the reduced-pressure source may be initiated in order to safely continue, following a rise in the air flow, with solvent extraction. By means of this design, the apparatus of the present invention is able to compensate temporary air flow fluctuations. However, in the event of a drop in the detected air flow below a predetermined limit value, a serious operational malfunction involving safety will have to be assumed, and as a consequence the microwave generator and any further electronic systems of the apparatus of the present invention preferably shall be shut down.

The source of partial vacuum may be in the form of various pumping devices or blowers.

A number of devices of the state of the art such as so-called paddle switches, in-line impeller meters, electronic mass flowmeters, pressure sensors etc. may be used as flow detectors. In an especially preferred design of the present invention, the flow detector shall be in the form of a mechanical differential-pressure switch, the differential pressure arising between two test sites in front of and after a constriction in the exhaust conduit. Because of the importance of safety, the flow detector preferably shall be redundant, both measurements being checked against each other. Illustratively membrane switches may be used that shall become operative in the presence of a minimum flow of air. If unequal test results are present, the microwave generator shall be shut down, and as a result the detection system assures especially high operational reliability.

In especially preferred manner, air-cooled specimen receptacles shall be used, the cooling airflow being guided along the receptacle outside wall to cool said receptacle. Moreover a gap to pass the air flow may be subtended between the specimen receptacle outside wall and an optional pressure-resistant external container or the inside of a receptacle support. In this design any leakage flows at the receptacle seals shall be entrained by the cooling air flow.

Because high pressures may be produced in the specimen receptacles when extracting solvents in the microwave field, the specimen receptacles preferably shall be pressure-resistant receptacles.

For such cases, the invention prefers specimen receptacles fitted with throttled overpressure valves or with rupture disks and a subsequent throttle that allow, in the event of excessively high pressure rises inside the receptacle, exhausting the gases and/or vapors in controlled manner from said receptacles' insides, whereby the pressure within the receptacle shall always remain less than a predetermined limit value. In the case of a response by the overpressure valve or if the rupture disk were to burst, the solvent vapors flowing into the microwaving chamber would immediately be entrained and evacuated by the flow of air in said chamber. By means of throttling and adjusted air flow, the solvent vapors shall be diluted and consequently the solvent concentration in said chamber shall always be less than the explosion limit, in the most adverse case preferably being less than 50%, advantageously being no more than about 25% of the concentration at the explosion limit. Typically the safeguard against excessive pressure is designed for a pressure of 25-30 bars, preferably about 30 bars at a temperature of about 250° C.

When using air-cooled specimen receptacles, the cooling air in the rotor is made to flow in the vicinity of the exhaust aperture. Consequently and advantageously the overpressure valves also shall be fitted with exhaust conduits terminating in the vicinity of the exhaust aperture, as a result of which the solvent vapors may be evacuated jointly with the flow of cooling air out of the microwaving chamber.

In one embodiment mode of the present invention, the overpressure valve exhaust conduits issue into a condensation vessel mounted in the microwaving chamber, the solvent vapors initially being cooled and condensed in said vessel. The solvent vapor generated merely by evaporation is then entrained out of the condensation vessel by means of the air flow, and as a result the above mentioned limit values of maximum solvent concentrations in the microwaving chamber may be obeyed even when using several specimen receptacles, for instance in a rotor, even assuming in a worst-case scenario that solvent vapors would issue from all specimen receptacles. As regards a worst-case analysis determining the airflow required to vent the microwaving chamber, advantageously that solvent shall be considered in calculations and empirical tests which exhibits good coupling into the microwave radiation, a low minimal explosion limit and high heat of evaporation. Illustratively ethanol is such a solvent which is well suited to the safety design of the apparatus of the invention.

Preferably the condensation vessel is made of a material transparent to microwaves, as a result of which the solvent vapors inside said vessel shall not be heated further.

Advantageously a cooling medium shall be present inside the condensation vessel in order that, said vessel being assumed microwave-transparent, a polar cooling medium, for instance water, also may be used.

The invention is elucidated below in relation to illustrative embodiments shown in the appended drawings.

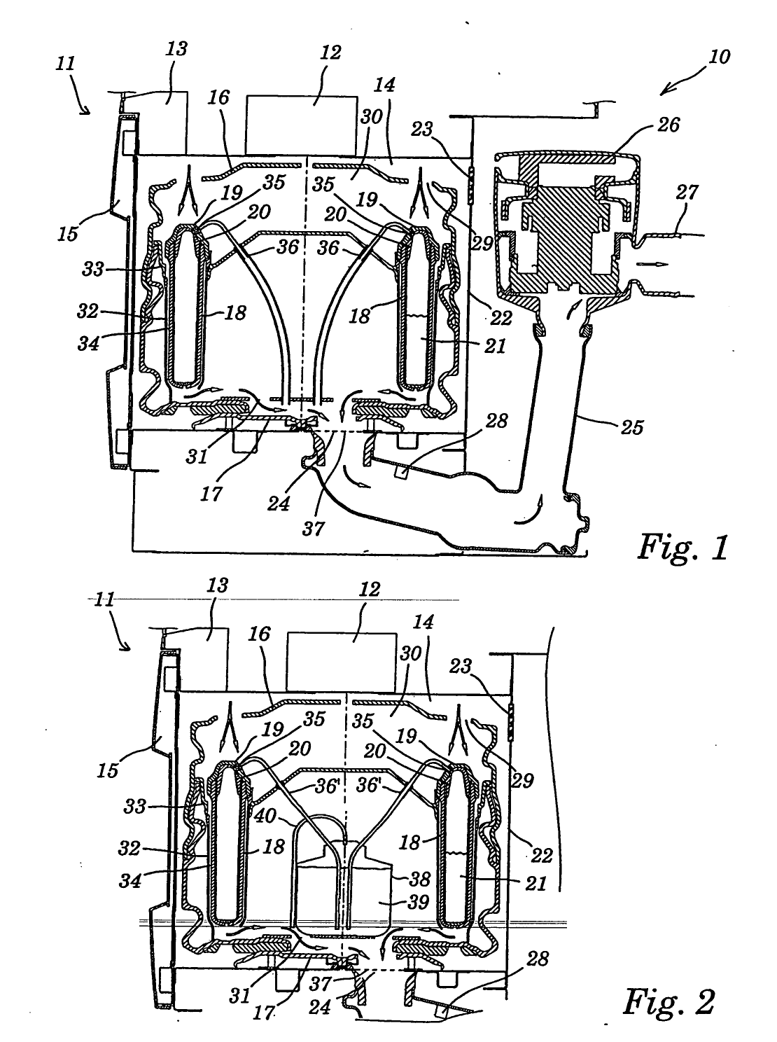

FIG. 1 is a first embodiment mode of the apparatus of the present invention to extract solvents in a microwave field, and

FIG. 2 is a variation of the apparatus of FIG. 1 shown in partial section and comprising a condensation vessel mounted in the microwaving chamber.

FIG. 1 is a cross-section of a first preferred embodiment mode of apparatus of the invention denoted as a whole by the reference 10 and serving to extract solvents in a microwave field. The solvent extracting apparatus 10 comprises a microwave oven 11 which is fitted with a microwave generator 12 and a control unit 13 and with at least one microwaving chamber 14. The microwaving chamber 14 is sealed by a microwave-tight door 15. A rotor 16 mounted in rotatable manner on a motor-driven turntable 17 is configured within the microwaving chamber 14. Pressure-resistant specimen receptacles 18 are mounted in the rotor 18 and are each sealed by a cap 19. A pressurized vessel seal 20 inside the cap 19 reliably seals the specimen receptacles 18. The specimen receptacles 18 are filled with solvent 21 and (omitted) specimen material which shall be processed by solvent extraction. The venting system of the invention must be activated before the microwave generator 12 may be turned ON. For that purpose one or more partitions 22 of the microwaving chamber 14 are fitted with venting apertures 23 allowing ambient air to enter the chamber 14. A suction exhaust aperture 24 is present at the bottom of the chamber 14 and is connected by an exhaust conduit 25 to an exhaust blower 26 which feeds the air aspirated from the chamber 14 through an exhaust hose 27 into an (omitted) laboratory exhaust duct or a conventional (also omitted) laboratory drain. A flow detector 28 is mounted downstream from the suction exhaust aperture 24 and measures the air flow in the exhaust conduit 25. The flow detector 28 is connected to the control unit 13 which in turn controls the operation of the microwave generator 12. The control unit 13 is designed in a manner that the microwave generator 12 may be turned ON only when the airflow measured by the flow detector 28 exceeds a predetermined limit value which is selected in a way to preclude forming an explosive mixture of solvent and air. Accordingly the minimal quantity of air is selected in such a way that under the most adverse condition, namely when solvent escapes from all containers 18 in the rotor 16, the solvent vapors still shall be diluted to such an extent that the solvent concentration in the mixture of solvents and air shall be below the explosion limit. Accordingly, during operation, that is while extraction is under way, the microwave generator 12 shall be turned OFF when the flow of air recorded by the flow detector 28 drops below the predetermined limit value. Therefore as regards the present invention, extraction shall NOT be interrupted immediately when malfunction arises, that is in the event of seal failure in one or more specimen receptacles, but instead only when, due to an operational malfunction of the exhaust blower 26, the minimum airflow required to safely operate the facility no longer can be maintained. Accordingly there may be seal failures or excessive pressures in certain specimen receptacles 18, but extraction may properly continue to termination in the remaining specimen receptacles. The rotor 16 is fitted with apertures 29 through which air is aspirated into the inner chamber 30 of the rotor 16 for the purpose of effectively exhausting any leaked solvent vapors. The air is aspirated through apertures 31 in the bottom of the rotor 16 into the suction exhaust aperture 24. This kind of rotor design already is known from applications involving the air-cooled specimen receptacles 18. For that purpose gaps 34 are subtended between the outer wall of the specimen receptacle 18 and the inner wall 32 of the receptacle supports 33 of the rotor 16, said gaps allowing the cooling air to flow down along the outside surface of the specimen receptacle 18. The specimen receptacles are fitted with a throttled overpressure valve 35 configured in the lid 19, said valve issuing into an exhaust line 36. When the overpressure valve 35 responds, solvent vapor shall be released in controlled, throttled manner from the inner space of the specimen receptacle 18 and be fed through the exhaust line 36 into a zone near the suction exhaust aperture 24 in the bottom of the microwaving chamber 14, as a result of which any leaked solvent vapors may be immediately sucked out of the microwaving chamber 14. Advantageously a metallic array 37 of circular apertures is configured in the suction exhaust aperture 24 to preclude microwaves leaking out of the microwaving chamber 14.

FIG. 2 is a partial section of a variation of the embodiment mode of FIG. 1, the exhaust conduit 25 and the exhaust air blower 26 having been omitted for clarity (see FIG. 1). In this variation the exhaust lines 36′ lead into a condensation vessel 38 which is filled with a cooling medium 39. Advantageously the condensation vessel 38 consists of a microwave-opaque material to also allow using also polar substances such as water as the cooling medium 39. If the vessel 37 on the other hand is made of a microwave-transparent material, a microwave-transparent cooling medium also may be used, for instance a non-polar liquid such as silicone oil. Again an overflow line 40 runs out of the condensation vessel 37 into the rotor bottom where any leaked solvent vapors may be immediately evacuated by suction from the chamber 14 through apertures 31 and through the suction exhaust aperture 24 in the bottom of the microwaving chamber 14.

1. Apparatus for extracting solvents in a microwave field, having:
a microwave oven (11) comprising at least one microwave generator (12), a control unit (13) and at least one microwaving chamber (14), said chamber being fitted with venting apertures (23) and at least one suction exhaust aperture (24) which is connected by an exhaust line (25) to a source (26) of partial vacuum,
a rotor (16) which is rotatably mounted in the microwaving chamber (14) and which comprises specimen receptacles (18) that may be filled with solvents,
characterized in that
a flow detector (28) is mounted downstream of the suction exhaust aperture (24) and reduces the power output of the microwave generator (12) when detecting a flow of air that is below a predetermined limit value, said air flow limit value being selected in a manner precluding forming an explosive mixture of solvent and air in the microwaving chamber (14).

2. Apparatus as claimed in claim 1, characterized in that the microwave generator (12) is turned OFF when the flow detector (28) detects a flow of air which is below the predetermined limit value.

3. Apparatus as claimed in one of claims 1 and 2, characterized in that the flow detector (28) is a differential pressure switch.

4. Apparatus as claimed in one of claims 1 through 3, characterized in that the specimen receptacles (18) are air-cooled.

5. Apparatus as claimed in one of claims 1 through 4, characterized in that the specimen receptacles (18) are designed as pressure-resistant receptacles.

6. Apparatus as claimed in claim 5, characterized in that the specimen receptacles are fitted with throttled overpressure valves (35).

7. Apparatus as claimed in claim 6, characterized in that the throttled overpressure valves (35) are fitted with exhaust lines (36, 36′) which terminate in the vicinity of the suction exhaust aperture (24).

8. Apparatus as claimed in claim 6, characterized in that the throttled overpressure valves (35) are fitted with exhaust lines (36′) which issue into a condensation vessel (38) configured in the microwaving chamber (14).

9. Apparatus as claimed in claim 8, characterized in that the condensation vessel (38) is made of a microwave-opaque material.

10. Apparatus as claimed in either of claims 8 and 9, characterized in that the condensation vessel (38) contains a cooling medium (39).

11. Apparatus as claimed in claim 10, characterized in that the cooling medium (39) is a liquid substantially transparent to microwave radiation.
